(19) United States
(12) Patent Application Publication
(10) Pub. No.: US 2026/0230681 A1
(43) Pub. Date: Aug. 6, 2026

(54) APPARATUS, METHOD, AND PROGRAM FOR SUBTITLE MANAGE-MENT BASED ON ARTIFICIAL INTELLIGENCE

(71) Applicant: INFLAB INC., Seongnam-si, Gyeonggi-do (KR)

(72) Inventors: Moonjoo KIM, Bucheon-si (KR); Jaeseok LEE, Yongin-si (KR); Sejeong UM, Seoul (KR); Seongryun JO, Yongin-si (KR)

(73) Assignee: INFLAB INC., Seongnam-si, Gyeonggi-do (KR)

(21) Appl. No.: 19/152,141

(22) PCT Filed: Apr. 9, 2024
(86) PCT No.: PCT/KR2024/004715

§ 371 Date: Jul. 30, 2025

(30) Foreign Application Priority Data
Nov. 24, 2023 (KR) 10-2023-0165037

(51) Int. Cl. H04N 21/488; H04N 21/43; H04N 21/466

(52) U.S. Cl. CPC H04N 21/4884; H04N 21/43074; H04N 21/4665

(57) ABSTRACT

According to the present disclosure, there is provided an artificial intelligence-based subtitle management apparatus, comprising: a subtitle generation unit, which obtains content data including video data and audio data from a first user terminal, generates first subtitle data synchronized based on time information of the audio data through a subtitle generation model, resynchronizes the first subtitle data based on motion information of the video data, matches the content data with the first subtitle data and provides the content data to a second user terminal; and a subtitle modification unit, which obtains a subtitle modification request including modification data from the second user terminal, modifies the first subtitle data based on the modification data to generate second subtitle data.

### TECHNICAL FIELD

Embodiments of the present disclosure relate to apparatus, method, and program for subtitle management based on artificial intelligence, and more particularly to apparatus, method, and programs for automatically generating subtitle data for content data and managing modifications of subtitle data.

### BACKGROUND ART

Recently, contents including video data of various topics have been provided to users online. Depending on the purpose of the video content, subtitles are increasingly provided for the speech contained in the video content.

In response to this trend, technologies are being actively developed to automate subtitle generation. A typical example is Speech-to-Text (STT) technology, which is a technology that interprets audio data spoken by humans and converts it into text data.

In the process of automatically converting audio data into text data and providing subtitles in synchronization with video content, a technology is required to improve the efficiency and accuracy of quality control and modification of automatically generated subtitles.

### DISCLOSURE

### Technical Problem

However, in such conventional subtitle generation techniques, there exists a problem that automatically generated subtitles frequently contain errors or are improperly synchronized with video data.

Embodiments of the present disclosure are intended to solve these problems, including the above problems, and provide artificial intelligence-based subtitle management apparatus, methods, and programs. However, these challenges are exemplary and do not limit the scope of the present disclosure.

### Technical Solution

According to one aspect of the present disclosure, an artificial intelligence-based subtitle management apparatus is provided. The apparatus comprises: a subtitle generation unit configured to acquire content data including video data and audio data from a first user terminal; to generate first subtitle data synchronized based on time information of the audio data using a subtitle generation model; a content provision unit configured to re-synchronize the first subtitle data based on motion information of the video data and to provide the content data and the first subtitle data to a second user terminal; and a subtitle modification unit configured to receive a subtitle modification request including modification data from the second user terminal, and to generate second subtitle data by modifying the first subtitle data based on the modification data.

According to this embodiment, the video data comprises a plurality of sequentially continuous frames, and the content provision unit is configured to classify the plurality of frames into a plurality of groups based on the motion information. In particular, when an N-th frame (where N is a positive integer) and an (N+1)-th frame include different motion information, the N-th frame and the (N+1)-th frame are classified into different groups.

According to this embodiment, the plurality of groups includes a first group and a second group that are sequentially arranged. When a portion of the first subtitle data corresponding to the first group also corresponds to motion information of the second group, the content provision unit may synchronize a start point of the portion corresponding to the first group with a start time of a first frame of the second group.

According to this embodiment, the subtitle modification unit is configured to determine a suitability score Of the subtitle modification request based on at least one of: a match rate between the modification data and the first subtitle data, and information related to the subtitle modification requester. When the suitability score exceeds a predetermined threshold, the subtitle modification unit modifies the first subtitle data to generate the second subtitle data.

According to this embodiment, when a start point of the first subtitle data and a start point of the second subtitle data differ in a modified portion, the content provision unit may synchronize the start point of the second subtitle data to match the start point of the first subtitle data.

According to this embodiment, when generating the second subtitle data, the subtitle modification unit may extract a modification keyword from the modification data, and update the second subtitle data by modifying a portion of the subtitle data containing the modification keyword to reflect the same.

According to this embodiment, the subtitle modification unit may search for content data similar to the modification keyword among other content data acquired by the subtitle generation unit, and may modify a portion of the subtitle data generated for the similar content data containing the modification keyword in the same manner.

According to this embodiment, the subtitle modification unit may provide the modification data to the subtitle generation unit. The subtitle generation unit may then use the modification data as training data to train the subtitle generation model. The trained subtitle generation model may subsequently generate subtitle data for new content data while reflecting the modification data.

According to one aspect of the present disclosure, a method for managing subtitles using artificial intelligence is provided. The method comprises: acquiring, by a subtitle generation unit, content data including video data and audio data from a first user terminal; generating, by the subtitle generation unit, first subtitle data synchronized based on time information of the audio data using a subtitle generation model; re-synchronizing, by a content provision unit, the first subtitle data based on motion information of the video data; providing the content data and the first subtitle data to a second user terminal; receiving, by a subtitle modification unit, a subtitle modification request including modification data from the second user terminal; and generating, by the subtitle modification unit, second subtitle data by modifying the first subtitle data based on the modification data.

According to one aspect of the present disclosure, a computer-readable recording medium is provided a non-transitory computer-readable recording medium storing program for executing the previously mentioned artificial intelligence-based open market management method in combination with a computer.

Other aspects, features, and advantages will become apparent from the following description of the invention, the claims, and the drawings.

Furthermore, these general and specific aspects may be implemented using a system, method, computer program, or any combination of systems, methods, and computer programs.

### ADVANTAGEOUS EFFECTS

According to the exemplary embodiments of the present disclosure made as described above, it is possible to implement an artificial intelligence-based subtitle management apparatus, method, and program that can efficiently generate, modify, and manage subtitles for content data without the involvement of a content creator. Of course, the scope of the present disclosure is not limited by these effects.

### BRIEF DESCRIPTION OF DRAWINGS

FIG. 1 is a conceptual diagram schematically illustrating a content delivery system according to an exemplary embodiment of the present disclosure.

FIG. 2 is a conceptual diagram schematically illustrating an operation of a subtitle management apparatus of a content delivery system according to an exemplary embodiment of the present disclosure.

FIG. 3 is a conceptual diagram schematically illustrating a subtitle data synchronization function according to an exemplary embodiment of the present disclosure.

FIG. 4 is an example diagram schematically illustrating a subtitle data synchronization function according to an exemplary embodiment of the present disclosure.

FIG. 5 is a conceptual diagram schematically illustrating a subtitle data modification function according to an exemplary embodiment of the present disclosure.

FIG. 6 is a conceptual diagram schematically illustrating a subtitle data modification function according to an exemplary embodiment of the present disclosure.

FIG. 7 is a flow diagram schematically illustrating a subtitle management method according to an exemplary embodiment of the present disclosure.

FIGS. 8 to 11 are example diagrams schematically illustrating a screen provided by a subtitle management apparatus according to an exemplary embodiment of the present disclosure.

### MODE FOR INVENTION

Since the present disclosure can be subjected to various transformations and can have various embodiments, certain embodiments will be illustrated in the drawings and described in detail in the detailed description. The effects and features of the present disclosure, and methods of achieving them, will become apparent upon reference to the embodiments described in detail with reference to the drawings. However, the present disclosure is not limited to the embodiments described below and may be implemented in various forms.

In the following embodiments, the terms first, second, and the like are not intended to be limiting, but are used to distinguish one component from another.

In the following embodiments, expressions of the singular include the plural unless the context clearly indicates otherwise.

In the following embodiments, terms such as comprising or having are intended to imply the presence of the features or components described and do not preclude the possibility of the addition of one more other features or components.

In the following embodiments, when a layer, region, component, or the like is described as being “on” or “above” another layer, region, component, or the like, it is intended to encompass both the case where it is directly on or above the other, and the case where one or more other layers, regions, components, or the like are interposed therebetween.

In the drawings, components may be exaggerated or reduced in size for ease of illustration. For example, the size and thickness of each configuration shown in the drawings is arbitrary for purposes of illustration and the present disclosure is not necessarily limited to those shown.

Certain sequences of operations may be performed in a different order than that described when certain embodiments are otherwise practicable. For example, two steps described in succession may be performed substantially simultaneously, or may be performed in the opposite order from that described.

As used herein, “A and/or B” refers to A, B, or A and B. And, “at least one of A and B” refers to A, B, or A and B.

In the following embodiments, references to layers, regions, components, etc. being connected include direct connections between layers, regions, components, etc. and/or indirect connections between layers, regions, components, etc. with other layers, regions, components, etc. interposed between them. For example, when referring herein to layers, regions, components, etc. being electrically connected, it refers to layers, regions, components, etc. being directly electrically connected and/or indirectly electrically connected with other layers, regions, components, etc. interposed between them.

The advantages and features of the present disclosure, and methods of achieving them, will become apparent upon reference to the embodiments described in detail with reference to the accompanying drawings. However, the present disclosure is not limited to the embodiments described below, but may be embodied in many different forms, and these embodiments are provided merely to make the disclosure complete and to fully inform those of ordinary skill in the Technical Field to which the disclosure belongs, and the disclosure is defined by the scope of the claims.

The terminology used in this disclosure is intended to describe embodiments and is not intended to limit the disclosure. As used in this disclosure, the singular may include the plural unless the context otherwise requires. As used in the disclosure, the words “comprises” and/or “comprising” do not exclude the presence or addition of one or more other components in addition to those mentioned. Throughout the disclosure, the same drawing symbols refer to the same components, and “and/or” may include each and every combination of one or more of the recited components. Although “first,” “second,” and the like are used to describe various components, the components are of course not limited by these terms. Thus, a first component referred to herein may also be a second component within the technical ideas of the present disclosure.

The word “exemplary” is used in this disclosure in the sense of “used as an example or illustration”. Any embodiment described as “exemplary” in this disclosure should not be construed as necessarily preferred or as having any advantage over other embodiments.

Embodiments of the present disclosure may be described in terms Of functions or blocks that perform functions. Blocks, which may be referred to as “parts” or “modules” of the disclosure, may be physically implemented by analog or digital circuits, such as logic gates, integrated circuits, microprocessors, microcontrollers, memory, passive electronics, active electronics, optical components, hardwired circuits, and the like, and optionally driven by firmware and software. Further, as used in the disclosure, the term “part” refers to software, hardware elements such as FPGAs or ASICs, and the “part” may perform any of these roles. However, “part” is not limited to software or hardware. A “part” may be configured to be on an addressable storage medium or may be configured to reproduce one or more processors. Thus, as one example, a “part” may include elements, such as software elements, object-oriented software elements, class elements, and task elements, processes, functions, attributes, procedures, subroutines, segments of program code, drivers, firmware, microcode, circuits, data, databases, data structures, tables, arrays, and variables. The functionality provided within the elements and “parts” may be combined into smaller numbers of elements and “parts” or further separated into additional elements and “parts”.

Embodiments of the present disclosure may be implemented using at least one software program running on at least one hardware device and performing network management functions to control the elements.

The spatially relative terms “below,” “beneath,” “lower,” “above,” “upper,” and the like may be used to facilitate describing the relationship of one component to another as shown in the drawings. Spatially relative terms may be understood to include different orientations of components in use or operation in addition to the orientations shown in the drawings. For example, a component described as “below” or “beneath” another component may be placed “above” another component when the components shown in the drawing are reversed. Thus, the exemplary term “below” can include both below and above orientations. Components may also be oriented in other directions, and accordingly, spatially relative terms may be interpreted according to their orientation.

Unless otherwise defined, all terms used in this disclosure, including technical and scientific terms, are intended to be used in the sense that would be understood by one of ordinary skill in the Technical Field to which this disclosure belongs. Furthermore, commonly used dictionary-defined terms are not to be construed as anomalous or excessive unless expressly specifically defined.

Embodiments of the present disclosure will now be described in detail with reference to the accompanying drawings, wherein identical or corresponding components are designated by the same drawing numerals and redundant descriptions are omitted.

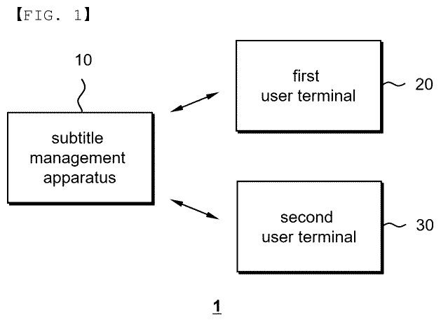

FIG. 1 is a conceptual diagram schematically illustrating a content delivery system in accordance with exemplary embodiments of the present disclosure.

As shown in FIG. 1, a content delivery system 1 according to an exemplary embodiment of the present disclosure may include a subtitle management apparatus 10, a first user terminal 20, and a second user terminal 30.

The subtitle management apparatus 10 is a device for processing and providing content data including video data and/or audio data. The form of the subtitle management apparatus 10 is not limited and may include any of a variety of devices capable of performing computational processing and providing results to a user. For example, the subtitle management apparatus 10 according to the present disclosure may be in the form of any one of a computer, a server device, and a portable terminal, or a combination of two or more of these.

The subtitle management apparatus 10 may be in communication with the first user terminal 20 and/or the second user terminal 30 and may transmit and receive data.

The subtitle management apparatus 10 may obtain content data from the first user terminal 20. The subtitle management apparatus 10 may process the content data acquired from the first user terminal 20. For example, the subtitle management apparatus 10 may generate subtitle data corresponding to the content data obtained from the first user terminal 20. The subtitle management apparatus 10 may match the content data obtained from the first user terminal 30 and the subtitle data generated by the subtitle management apparatus 10 and provide it to the second user terminal 30.

Here, the content data may include video data and audio data. The video data is data including a video signal conveying visual information. The audio data is data comprising audio signals conveying voice-based auditory information. The content data may further include data comprising audio signals conveying non-voice-based auditory information (e.g., background sounds, sound effects, etc.).

The format of the content data may be any one of, but not limited to, MP4, MOV, WMV, AVI, AVCHD, FLV, F4V, SWF, MKV, WEBM, HTML5, and the format of the subtitle data may be any one of, but not limited to, SRT, SBV, SUB, MPSUB, LRC, CAP, SMI, SAMI, RT, VTT, TTML, DFXP.

The subtitle management apparatus 10 may perform modification and management operations on the generated subtitle data. In one embodiment, the subtitle management apparatus 10 may acquire a modification request for the subtitle data from the second user terminal 30, and modify the subtitle data based on the modification data included in the acquired modification request. In other words, the subtitle management apparatus 10 may not only modify the subtitle data arbitrarily, but may also perform subtitle modification operations through communication with a user of the content delivery system 1.

The first user terminal 20 is a terminal of a first user who provides content data to the subtitle management apparatus 10. In other words, the first user terminal 20 is a terminal of a user who creates a video for supplying to another user.

The second user terminal 30 is a terminal of a second user that receives content data from the subtitle management apparatus 10. For example, the second user terminal 30 may be a terminal of a user who watches content managed by the subtitle management apparatus 10.

The second user terminal 30 may provide a request for modification of subtitle data for the content data provided to the subtitle management apparatus 10. The subtitle management apparatus 10 may modify the subtitle data based on the modification data included in the subtitle modification request obtained from the second user terminal 30. Further, the subtitle management apparatus 10 may determine the suitability of the subtitle modification request obtained from the second user terminal 30, and may perform the subtitle modification operation only if it is determined to be suitable. A detailed description of this will be described later.

On the other hand, the first user terminal 20 and the second user terminal 30 are devices capable of wireless communication, and are not limited in form. For example, the first user terminal 20 and the second user terminal 30 according to the present disclosure may be portable terminals such as computers, smartphones, and the like.

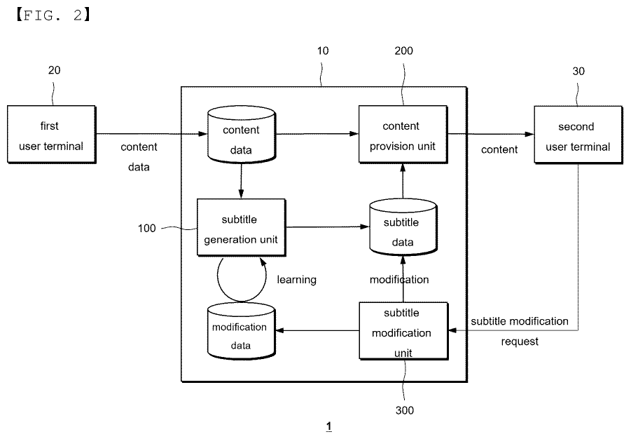

FIG. 2 is a conceptual diagram schematically illustrating operation of a subtitle management apparatus of a content delivery system according to an exemplary embodiment of the present disclosure.

As shown in FIG. 2, the subtitle management apparatus 10 may include a subtitle generation unit 100, a content provision unit 200, and a subtitle modification unit 300.

The subtitle generation unit 100 plays a role in acquiring content data including video data and audio data from the second user terminal 20, and automatically generating synchronized first subtitle data based on time information of the audio data through a subtitle generation model for the acquired content data. For this purpose, the subtitle generation unit 100 may include a subtitle generation model. Here, the subtitle generation model may include a speech-to-text (STT) model, and there is no limitation on the type of STT application programming interface (API).

Specifically, the subtitle generation unit 100 may selectively extract audio data from the video data and audio data comprising the content data obtained from the second user terminal 20. The subtitle generation unit 100 may selectively extract audio data from the audio data and non-voice data including the extracted audio data.

The subtitle generation unit 100 may generate subtitle data by converting the extracted audio data into character data. In this case, the subtitle data generated by the subtitle generation unit 100 may be synchronized subtitle data based on the time information of the audio data. That is, the subtitle generation unit 100 recognizes the audio data over time and generates text data that has undergone natural language processing by matching the time information of the audio signals of the audio data to the time information of the audio data, thereby generating synchronized subtitle data based on the time information of the audio data.

On the other hand, the subtitle generation unit 100 may reinforcement learn the subtitle generation model by utilizing the modification data of the subtitle modification unit 300 described later as training data. That is, the subtitle modification unit 300 provides the modification data to the subtitle generation unit 100 when the subtitle modification operation is performed, and the subtitle generation unit 100 learns the subtitle generation model based on the obtained modification data. When the subtitle generation model trained on the modification data is used to generate subtitle data for the new content data, the subtitle data may be generated by reflecting the modification data. In this way, the subtitle generation unit 100 is able to perform a more accurate subtitle generation operation by continuously accumulating and learning the modification data.

The content provision unit 200 plays a role in matching the content data obtained from the first user terminal 20 and the subtitle data generated by the subtitle generation unit 100 for the content data and providing it to the second user terminal 30.

On the other hand, the subtitle data synchronized based on the time information of the audio data generated by the subtitle generation unit 100 may have a mismatch with the motion information of the video data (e.g., the screen being provided) in the process of providing or watching the content data.

In one embodiment, the content data may be lecture content data. The lecture content data may include video data including a lecturer, and audio data including a description of the lecture content. The video data including the lecture content may include behavioral information related to the lecture content (e.g., displaying a specific page of the lecture content, playing a video embedded in the specific page, executing a special effect embedded in the specific page, turning to the next page, etc. Further, the audio data including the lecture content description may include an audio signal of an instructor's voice generated based on time information.

The subtitle generation unit 100 may generate synchronized subtitle data based on the time information of the audio data including the lecture content description. Since the subtitle data generated by the subtitle generation unit 100 is synchronized with the time information of the audio data, in a part where the video data including the lecture material and the audio data including the lecture content description are mismatched, the subtitle data is also mismatched with the video data. For example, if the lecturer in the lecture content data explains the contents of the next page before turning the page of the lecture material, the motion information in the video data is the lecture material for the current page, and the audio data is the lecture content explanation for the next page, so the video data and audio data are inconsistent. Similarly, the subtitle data also becomes inconsistent with the video data.

According to embodiments of the present disclosure, by resynchronizing at least a portion of the subtitle data based on motion information rather than time information, the subtitle data can be provided with a more accurate match to the content data. As a result, viewers may be provided with more accurate subtitle data corresponding to the video data, thereby improving their understanding of the content data.

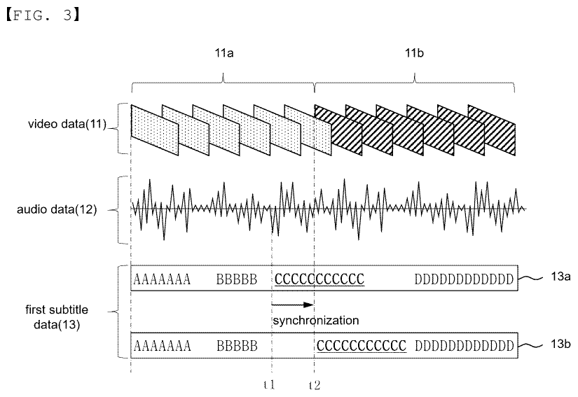

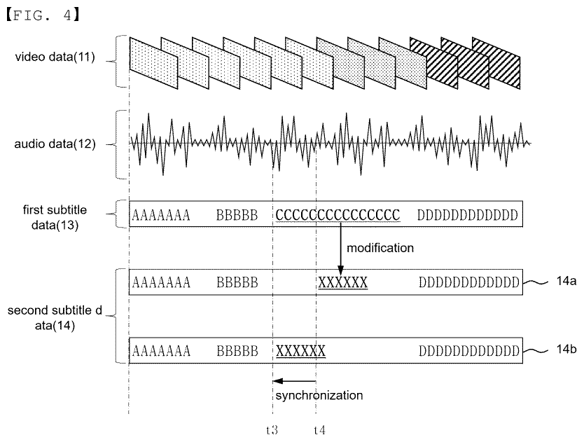

In one embodiment, the content provision unit 200 may resynchronize the first subtitle data generated by the subtitle generation unit 100 by synchronizing it based on time information of the audio data of the content data, resynchronize it based on motion information of the video data of the content data, and provide the content data and the first subtitle data to the second user terminal 20. A detailed description of such resynchronization based on the motion information will be described later with reference to FIGS. 3 and 4.

The subtitle modification unit 300 plays a role in generating second subtitle data by modifying the first subtitle data generated by the subtitle generation unit 100.

In one embodiment, the subtitle modification unit 300 may obtain a subtitle modification request including modification data from the second user terminal 30, and may modify the first subtitle data based on the modification data to generate the second subtitle data.

The modification data may include a modification request portion of the first subtitle data and an amendment. The subtitle modification unit 300 may manage the subtitle data as a corpus divided by a preset criterion to distinguish the modification request portion. For example, the subtitle modification unit 300 may manage the subtitle data as a corpus unititioned based on at least one of a sentence unit, a clause unit, a word unit, a letter unit, a morpheme unit, and a sentence component unit (e.g., subject, predicate, complement, object, adverb, adverbial, article, independent). Accordingly, the subtitle modification unit 300 may determine which portion of the subtitle data the modification request is for, and may perform modification operations only on that portion of the subtitle data.

The subtitle modification unit 300 may determine the suitability of the subtitle modification request for the reliability of the subtitle modification, perform the subtitle modification operation only if it is determined to be suitable, and reject the modification request if it is determined to be unsuitable.

In one embodiment, the subtitle modification unit 300 may determine the suitability of the subtitle modification request based on at least one of the match rate of the modification data with the first subtitle data and the subtitle modification requestor information, and may modify the first subtitle data to generate second subtitle data if the suitability is above a threshold.

The subtitle modification unit 300 may extract a corpus corresponding to the modification request portion of the modification data from the first subtitle data, and may analyze a match rate of the extracted corpus and the modification of the modification data. At this time, the subtitle modification unit 300 may adjust the scope of the corpus unit to be wider or narrower depending on the scope of the modification request portion. The subtitle modification unit 300 may calculate a conformance as a higher match rate between the corpus source extracted from the subtitle data and the correction for that corpus. The subtitle modification unit 300 may determine that a subtitle modification request is suitable if the match rate between the corpus original and the modification for that corpus is above a threshold (or if the calculated fitness is above a threshold).

Further, the subtitle modification unit 300 may analyze the subtitle modification requestor information that provided the subtitle modification request. The subtitle modification unit 300 may analyze the subtitle modification requestor information based on, for example, the type of subtitle modification requestor (content provider or content viewer), subtitle modification history, similar content viewing history, or Supply history to determine the suitability Of the subtitle modification request. For example, the subtitle modification unit 300 may calculate a higher suitability if the type of the subtitle modification requestor is a content provider than if the type of the requestor is a content viewer, and a higher suitability if the type of the requestor has a history of subtitle modification, a history of viewing similar content, or a supply history. The subtitle modification unit 300 may modify the first subtitle data to generate the second subtitle data if the suitability calculated by analyzing the subtitle modification requestor information is above a threshold.

On the other hand, the subtitle modification unit 300 may also calculate the conformity of the modification request by utilizing both the above modification data and the match rate of the first subtitle data and the subtitle modification requestor information. The subtitle modification unit 300 may set the weight of the match rate of the modification data and the first subtitle data and the subtitle modification requestor information differently.

As a specific example, the subtitle modification unit 300 may assign a higher weight to the content of the subtitle modification request than to the subject of the subtitle modification request, i.e., the subtitle modification unit 300 may set the weight for the match rate of the modification data and the first subtitle data higher than the weight for analyzing the subtitle modification requestor information.

As another specific example, the subtitle modification unit 300 may assign a lower weight to the content of the subtitle modification request than to the subject of the subtitle modification request; that is, the subtitle modification unit 300 may set the weight for the match rate of the correction data and the first subtitle data to be lower than the weight for analyzing the subtitle modification requestor information.

In one embodiment, the subtitle modification unit 300 may provide a reward to the subtitle modification requestor who provided the subtitle modification request when a subtitle modification operation is performed based on the subtitle modification request.

FIG. 3 is an example diagram schematically illustrating a subtitle data synchronization function according to an exemplary embodiment of the present disclosure.

As shown in FIG. 3, content provided to a second user terminal 30 (see FIG. 2) may include video data 11, audio data 12, and subtitle data 13.

The video data 11 may include a plurality of frames that are sequentially consecutive. The plurality of frames may vary in number of frames per unit of time based on a frame rate. For example, the frame rate may be, but is not limited to, 24 fps, 30 fps, 60 fps, etc.

The content provision unit 300 (see FIG. 2) may categorize the plurality of frames comprising the video data 11 into a plurality of groups based on motion information. The content provision unit 200 may analyze the motion information included by each of the plurality of frames, classify frames with the same motion information into the same group, and classify frames with different motion information into different groups.

In one embodiment, the content provision unit 200 may categorize the Nth (wherein N is a positive integer) frame and the N+1st frame of the plurality of frames comprising the video data 11 into different groups if the Nth frame and the N+1st frame comprise different motion information.

Similarly, the content provision unit 200 may categorize the Nth (wherein N is a positive integer) frame and the N+1st frame of a plurality of frames comprising the video data 11 into the same group if the Nth frame and the N+1st frame comprise the same motion information.

As shown in FIG. 3, the plurality of groups categorized by the content provision unit 200 may include a first group 11a and a second group 11b that are sequentially consecutive, wherein the frames included in the first group 11a are frames that include the same motion information as each other, and the frames included in the second group 11b are frames that include the same motion information as each other, but include different motion information than the frames included in the first group 11a.

The content provision unit 200 may perform sequentially from comparing the motion information of the first frame and the second frame of the video data 11 to comparing the motion information of the last frame and the frame immediately preceding the last frame. The content provision unit 200 may sequentially perform the motion information comparison of the two consecutive frames as described above, and may categorize a group if the Nth frame and the N+1st frame with different motion information are found. In this case, the first frame to the Nth frame may be classified as the first group 11a, and the N+1st frame may be classified as the second group 11b. Similarly, if the Mth (where M is a positive integer greater than N+1) frame and the M+1st frame with different behavioral information are found, the N+1st frame to the M+1st frame may be classified as the second group 11b, and the M+1st frame may be classified as the third group.

In one embodiment, the content provision unit 200 may determine whether the motion information between frames is the same based on at least one of a code assigned to the content, a category, a topic, content introductory text content, provider information, viewer information, video progress, visual information (e.g., lecture material images and text) analysis content, and subtitle data content.

The first subtitle data 13 may include synchronized first subtitle data 13a based on time information of the audio data 12 and synchronized first subtitle data 13b based on motion information of the video data 11. The content provision unit 200 may resynchronize the synchronized first subtitle data 13a based on the time information of the audio data 12 to the motion information of the video data 11.

In one embodiment, the content provision unit 200 may synchronize the starting point T1 of the portion matched to the first group 11a of the video data 11 to coincide with the starting point T2 of the first frame of the second group 11b of the video data 11 when the portion matched to the first group 11a in the synchronized first subtitle data 13a based on the time information of the audio data 12 corresponds to the motion information of the second group 11b.

For example, referring to FIG. 3, it can be seen that the “CCCCCCCCCCC” portion of the first subtitle data 13 is matched to the first group 11a, but since the “CCCCCCCCCCC” portion corresponds to the motion information of the second group 11b, the start point t1 of the “CCCCCCCCCCC” portion is synchronized to match the start point t2 of the first frame of the second group 11b.

FIG. 4 is an example diagram schematically illustrating a subtitle data synchronization function according to an exemplary embodiment of the present disclosure.

As shown in FIG. 4, the subtitle modification unit 300 (see FIG. 2) may modify the first subtitle data 13 generated by the subtitle generation unit 100 (see FIG. 2) to generate second subtitle data 14.

The second subtitle data 14 may include second subtitle data before the synchronization 14a based on the subtitle modification and second subtitle data after the synchronization 14b based on the subtitle modification.

In one embodiment, the content provision unit 200 (see FIG. 2) may synchronize the starting point T3 of the first subtitle data 13 and the starting point T4 of the second subtitle data 14 to match the starting point T3 of the first subtitle data when the starting point T4 of the second subtitle data 14 is different for the modified portion based on the subtitle modification request. In other words, the content provision unit 200 may synchronize the starting point T4 of the portion modified by the subtitle modification operation in the second subtitle data before the synchronization 14a based on the subtitle modification to the starting point T3 of the first subtitle data 13 before the modification of the portion, and generate the second subtitle data after the synchronization 14b based on the subtitle modification.

For example, referring to FIG. 4, it can be seen that the starting point of the “CCCCCCCCCCCCCCC” portion of the first subtitle data 13 has been modified to “XXXXXX”, and the starting point of the “XXXXXX” portion has been synchronized to match the starting point t3 of the “CCCCCCCCCCCCCCCCC” portion of the existing first subtitle data 13.

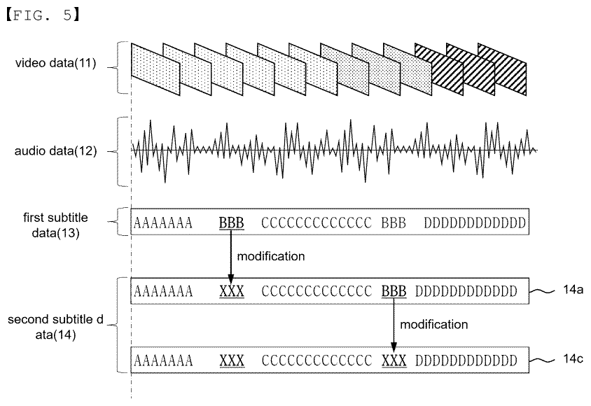

FIG. 5 is a conceptual diagram schematically illustrating a subtitle data modification function according to an exemplary embodiment of the present disclosure.

As shown in FIG. 5, the subtitle modification unit 300 (see FIG. 2) may modify at least a portion of the first subtitle data 13 to generate second subtitle data 14. The subtitle modification unit 300 may perform additional subtitle modifications based on the modified data to update the second subtitle data 14. Accordingly, the second subtitle data 14 may include the second subtitle data before the update 14a and the second subtitle data after the update 14c.

In one embodiment, when the subtitle modification unit 300 generates the second subtitle data 14, the subtitle modification unit 300 may extract a modification keyword from the modification data, and update the second subtitle data 14 by modifying the portion of the second subtitle data 14 that includes the modification keyword accordingly. In other words, the subtitle modification unit 300 may extract the modification keyword that is the core of the content of the modification of the first subtitle data 13, and further search for the portion containing the extracted modification keyword in the second subtitle data before the update 14a, and perform the same modification operation to generate the second subtitle data after the update 14c.

For example, referring to FIG. 5, the first subtitle data 13 includes a “BBB” portion in two places, a front part and a latter part. From the second user terminal 30 (see FIG. 2), a request to modify the “BBB” portion at the front part of the first subtitle data 13 to “XXX” may be obtained. Accordingly, the subtitle modification unit 300 may modify the “BBB” portion of the front part to “XXX” to generate the second subtitle data before update 14a. The subtitle modification unit 300 may then set “BBB” as the modification keyword for the present subtitle modification operation, and may further search for the portion of the second subtitle data before update 14a containing “BBB” to extract the portion of “BBB” at the latter part. The subtitle modification unit 300 may modify the extracted “BBB” portion at the latter part to “XXX”, the same as the “BBB” portion of the front part, to generate the second subtitle data after the update 14c.

With this additional subtitle modification operation, the modification operation provided by the subtitle modification requestor can be performed on the entire subtitle data, enabling more efficient subtitle modification and improving the overall subtitle quality.

On the other hand, the subtitle modification unit 300 may increase the compensation to the subtitle modification requestor in proportion to the number of portions in which the additional subtitle modification operations described above are performed.

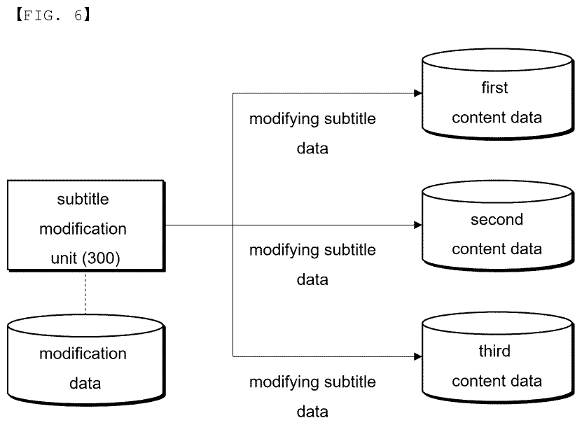

FIG. 6 is a conceptual diagram schematically illustrating a subtitle data modification function according to an exemplary embodiment of the present disclosure.

As illustrated in FIG. 6, a content delivery system 1 (see FIG. 2) may obtain a plurality of content data from a first user terminal 20 (see FIG. 2) and provide a plurality of content to a second user terminal 30 (see FIG. 2).

The subtitle modification unit 300, see FIG. 2, may perform additional subtitle modification operations on other content data in which similar subtitle errors are likely to exist based on modification data from a subtitle modification operation performed on one of the content data.

In one embodiment, the subtitle modification unit 300 may perform a subtitle modification operation on the at least one content data, and extract a modification keyword from the modification data of the subtitle modification operation. The subtitle modification unit 300 may search for similar content data related to the modification keyword among other content data acquired by the subtitle generation unit 100 (see FIG. 2) to generate subtitle data, and may modify the portion containing the modification keyword in the subtitle data generated for the similar content data accordingly.

For example, referring to FIG. 6, the subtitle modification unit 300 may explore one or more other content data that is highly related to the modification keyword. The subtitle modification unit 300 may analyze the subtitle data generated for the one or more explored content data to determine whether a subtitle error associated with the modification keyword exists. If a subtitle error associated with the modification keyword is found, the subtitle modification unit 300 may perform the same subtitle modification operation based on the modification data.

Such a cascade of additional subtitle modification operations has the effect of improving the overall subtitle quality for the plurality of content data registered in the content delivery system 1.

On the other hand, the subtitle modification unit 300 may increase the compensation to the subtitle modification requestor in proportion to the number of additional subtitle modification operations when the additional subtitle modification operations are performed.

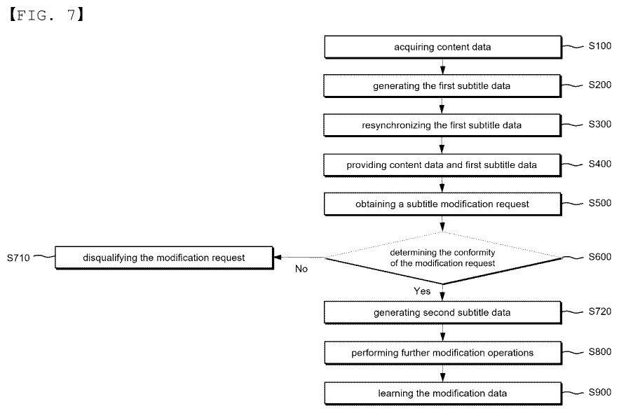

FIG. 7 is a flow diagram schematically illustrating a subtitle management method according to an exemplary embodiment of the present disclosure.

As shown in FIG. 7, a subtitle management method according to an exemplary embodiment of the present disclosure includes a step of obtaining content data (S100), a step of generating first subtitle data (S200), a step of resynchronizing first subtitle data (S300), and a step of providing content data and first subtitle data (S400), obtaining a subtitle modification request (S500), determining conformity of the modification request (S600), disqualifying the modification request (S710), generating second subtitle data (S720), performing further modification operations (S800), and learning the modification data (S900).

Hereinafter, identical drawing symbols in the drawings denote the same components, and the description of the overlapping content of the foregoing will be omitted.

The step of acquiring content data (S100, see FIG. 2) of the method is a step in which the subtitle generation unit (100, see FIG. 2) acquires content data including video data and audio data from the first user terminal (20, see FIG. 2).

The step of generating the first subtitle data (S200) is a step in which the subtitle generation unit 100 generates the synchronized first subtitle data based on the time information of the audio data through a subtitle generation model.

The step of resynchronizing the first subtitle data (S300) is a step in which the content provision unit (200, see FIG. 2) resynchronizes the first subtitle data based on motion information of the video data.

The step of providing content data and first subtitle data (S400) is a step in which the content provision unit (200, see FIG. 2) provides the content data and the first subtitle data to the second user terminal (30, see FIG. 2) by matching the content data and the first subtitle data.

The step of obtaining a subtitle modification request (S500) is a step in which the subtitle modification unit (300, see FIG. 2) obtains a subtitle modification request including the modification data from the second user terminal (30, see FIG. 2).

The step determining the conformity of the modification request (S600) is a step in which the subtitle modification unit 300 determines the conformity of the subtitle modification request based on at least one of a match rate of the modification data with the first subtitle data and information of the subtitle modification requestor.

The step of disqualifying the modification request (S710) is a step in which the subtitle modification unit 300 disqualifies the subtitle modification request if the subtitle modification unit 300 determines that the subtitle modification request is disqualified (the conformity of the subtitle modification request is below a threshold).

The step of generating second subtitle data (S720) is a step in which, if the subtitle modification unit 300 determines that the subtitle modification request is suitable (if the suitability of the subtitle modification request is above the threshold), the subtitle modification unit 300 modifies the first subtitle data based on the modification data to generate second subtitle data.

The step of performing further modification operations (S800) is a step in which the subtitle modification unit 300 performs further subtitle modification operations based on the modification data.

In one embodiment, the step of performing further modification operations (S800) may include a step wherein the subtitle modification unit 300 performs further subtitle modification operations based on the modification data to update the second subtitle data 14.

Specifically, the step of performing the further modification operation S800 may include, if the subtitle modification unit 300 has generated the second subtitle data 14, extracting a modification keyword from the modification data, and updating the second subtitle data 14 by modifying the portion of the second subtitle data 14 that includes the modification keyword accordingly.

In one embodiment, the step of performing further correction operations (S800) may include the step of performing further subtitle correction operations on other content data in which similar subtitle errors are likely to exist based on the correction data of the subtitle correction operations performed by the subtitle modification unit 300 on the one content data.

Specifically, the step of performing the additional correction operation (S800) may include the steps of performing a subtitle modification operation on the one content data by the subtitle modification unit 300, extracting a correction keyword from the correction data of the subtitle modification operation, searching for similar content data related to the correction keyword among other content data acquired by the subtitle generation unit 100 and for which the subtitle data was generated, and equally correcting a portion of the subtitle data generated for the similar content data that includes the correction keyword.

The step of learning the modification data (S900) is a step in which the subtitle modification unit 300 provides the modification data to the subtitle generation unit 100, and the subtitle generation unit 100 utilizes the modification data as training data to learn the subtitle generation model. When the subtitle generation model that has learned the modification data is used to generate subtitle data for the new content data, subtitle data can be generated by reflecting the modification data.

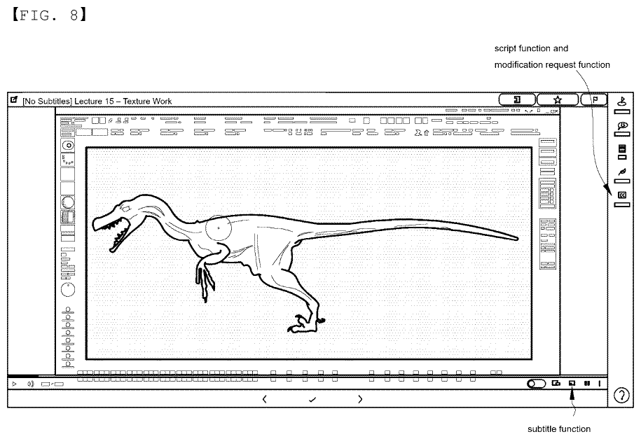

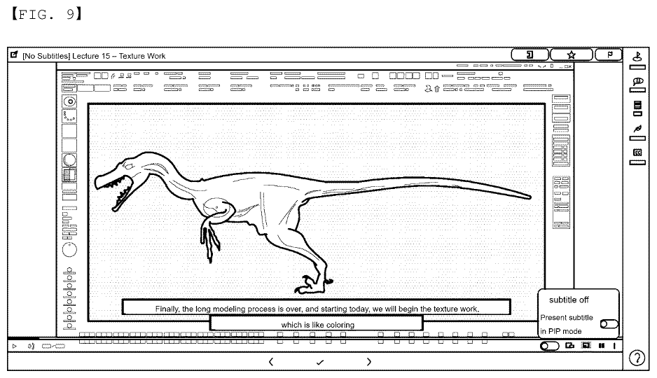

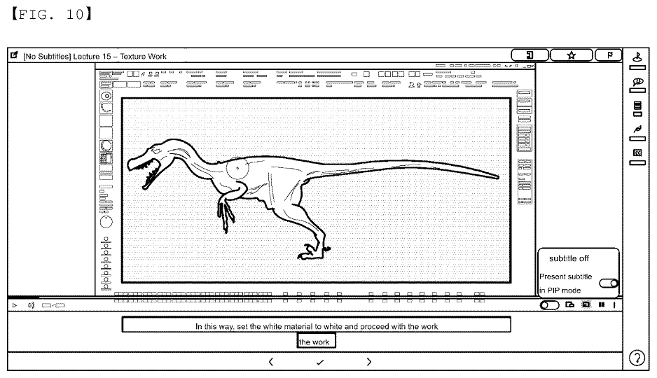

FIGS. 8 to 11 are exemplary diagrams schematically illustrating a screen provided by a subtitle management apparatus according to an exemplary embodiment of the present disclosure.

As shown in FIGS. 8 to 10, a subtitle management apparatus 10 (see FIG. 2) according to an exemplary embodiment of the present disclosure may include at least one of a subtitle feature activation button, a script activation button, and a subtitle (or script) modification request button on a screen providing content.

The subtitle function activation button may set whether or not to display subtitle data corresponding to video data comprised by the content being provided. For example, the subtitle management apparatus 10 may provide a menu for turning off/on subtitles or setting a display position of subtitles when the subtitle function activation button is clicked. Such an enable closed captioning button may be displayed in the lower right-hand corner of the screen, but may be placed at any location on the content delivery screen, including, but not limited to, the bottom right-hand corner of the screen.

In one embodiment, the subtitle management apparatus 10 may provide subtitle data in overlap with at least a portion of the video data. In another embodiment, the subtitle management apparatus 10 may be positioned on one side of the video data (e.g., bottom, top, left, right, etc.) such that the subtitle data does not overlap with the video data. The position of such subtitle data display may be controlled via the subtitle function activation button.

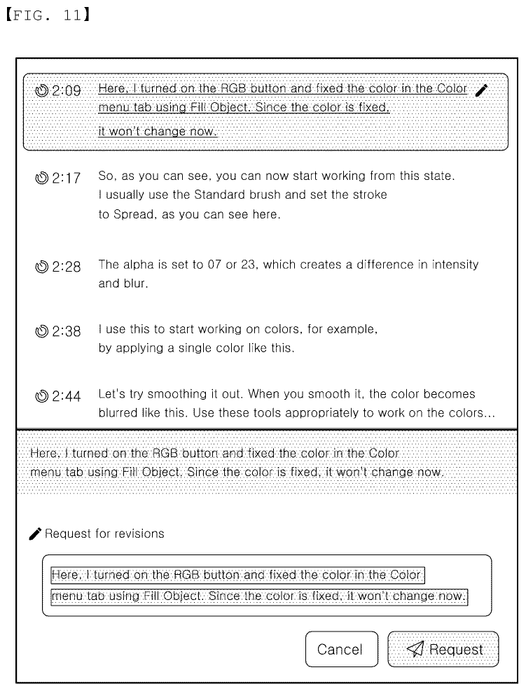

The script enable button may set whether or not to display script data corresponding to the video data comprising the provided content. Here, the script data is data that includes the entirety of the subtitle data provided over the course of the playback time of the video data. Referring to FIG. 11, the script data may be displayed by classifying the subtitle data according to a preset criterion, and matching time information of the audio data for each classified subtitle data. Further, the subtitle data in the script data may be displayed sequentially according to the time information. In one embodiment, selecting a portion of the subtitle data comprising the script data can display video data corresponding to the time information matched to the subtitle data. This enables a content viewer to conveniently search for video data corresponding to a particular subtitle data.

In one embodiment, a user viewing the content can activate the script data and instantly make a modification request for at least a portion of the subtitle data that the script data includes. For example, as shown in FIG. 11, the content viewer may select at least a portion of the subtitle data included in the subtitle script data, and enter a modification for the selected subtitle data. The subtitle modification unit 300 (see FIG. 2) may obtain the user-input modification data, determine the appropriateness of the subtitle modification request, and perform the subtitle modification operation.

The subtitle management apparatus 10 may provide a menu for turning scripts off/on or setting a display location for scripts when a script activation button is clicked. Such a script feature enable button may be displayed on the right side of the screen, but may be positioned anywhere on the content delivery screen, including, but not limited to, the right side of the screen.

The present disclosure has been described with reference to the embodiments shown in the drawings, but these are exemplary only, and those having ordinary skill in the technical field will understand that various modifications and other equally valid embodiments are possible from them, and the true technical scope of the present disclosure should therefore be determined by the technical ideas of the appended claims.

1. An artificial intelligence-based subtitle management apparatus comprising:
a subtitle generation unit configured to acquire content data including video data and audio data from a first user terminal, and to generate first subtitle data synchronized based on time information of the audio data using a subtitle generation model;
a content provision unit configured to re-synchronize the first subtitle data based on motion information of the video data, and to provide the content data and the first subtitle data to a second user terminal in a matched manner; and
a subtitle modification unit configured to receive a subtitle modification request including modification data from the second user terminal, and to generate second subtitle data by modifying the first subtitle data based on the modification data,
wherein the video data comprises a plurality of sequentially continuous frames,
wherein the content provision unit is further configured to:
classify the plurality of frames into a plurality of groups based on the motion information,
wherein, when an N-th frame (where N is a positive integer) and an (N+1)-th frame among the plurality of frames include different motion information, the N-th and (N+1)-th frames are classified into different groups; and
wherein the subtitle modification unit is further configured to:
determine a suitability of the subtitle modification request based on at least one of a matching rate between the modification data and the first subtitle data, and information related to the subtitle modification requester; and
when the suitability exceeds a threshold, modify the first subtitle data to generate the second subtitle data.

2. The apparatus of claim 1,
wherein the plurality of groups comprises a first group and a second group that are sequentially continuous,
wherein the content provision unit is further configured to:
when a portion of the first subtitle data corresponding to the first group also corresponds to motion information of the second group, synchronize a start point of the portion corresponding to the first group to match a start time of a first frame of the second group.

3. The apparatus of claim 1,
wherein the content provision unit is further configured to:
when a start point of the first subtitle data and a start point of the second subtitle data corresponding to a modified portion differ based on the subtitle modification request, synchronize the start point of the second subtitle data with the start point of the first subtitle data.

4. The apparatus of claim 3,
wherein the subtitle modification unit is further configured to:
when the second subtitle data is generated, extract a modification keyword from the modification data, and update the second subtitle data by modifying a portion including the modification keyword to reflect the same.

5. The apparatus of claim 4,
wherein the subtitle modification unit is further configured to:
search for similar content data related to the modification keyword among other content data for which subtitle data has been generated by the subtitle generation unit, and modify a portion including the modification keyword in the subtitle data of the similar content data in the same manner.

6. The apparatus of claim 5,
wherein the subtitle modification unit is further configured to provide the modification data to the subtitle generation unit,
wherein the subtitle generation unit is configured to use the modification data as training data to train the subtitle generation model,
wherein the trained subtitle generation model is configured to generate subtitle data for new content data by reflecting the modification data.

7. The apparatus of claim 1,
wherein the subtitle modification unit is further configured to:
manage the subtitle data in corpus units divided based on a predetermined criterion,
extract a corpus corresponding to the modified portion of the modification data from the first subtitle data, and
calculate the suitability to be higher when a similarity between an original of the extracted corpus and a modification to the corpus is higher.

8. The apparatus of claim 1,
wherein the subtitle modification unit is further configured to:
determine a higher suitability when the subtitle modification requester is a content provider than when the requester is a content viewer, and
determine a higher suitability as the subtitle modification history, similar content viewing history, or content provision history of the requester increases.

9. A method for managing subtitles using artificial intelligence, the method comprising:
acquiring, by a subtitle generation unit, content data including video data and audio data from a first user terminal;
generating, by the subtitle generation unit, first subtitle data synchronized based on time information of the audio data using a subtitle generation model;
re-synchronizing, by a content provision unit, the first subtitle data based on motion information of the video data;
providing the content data and the first subtitle data to a second user terminal in a matched manner;
receiving, by a subtitle modification unit, a subtitle modification request including modification data from the second user terminal; and
generating, by the subtitle modification unit, second subtitle data by modifying the first subtitle data based on the modification data,
wherein the video data comprises a plurality of sequentially continuous frames,
wherein the method further comprises:
classifying the plurality of frames into a plurality of groups based on the motion information,
wherein, when an N-th frame (where N is a positive integer) and an (N+1)-th frame among the plurality of frames include different motion information, the N-th and (N+1)-th frames are classified into different groups,
wherein the suitability of the subtitle modification request is determined based on at least one of a matching rate between the modification data and the first subtitle data, and information related to the subtitle modification requester, and
wherein the first subtitle data is modified to generate the second subtitle data when the suitability exceeds a threshold.

10. A non-transitory computer-readable recording medium storing a program that, when executed by a computer, causes the computer to perform the method of claim 9.
